(19) United States
(12) Patent Application Publication
(10) Pub. No.: US 2003/0027579 A1
(43) Pub. Date: Feb. 6, 2003

(54) System for and method of providing an air interface with variable data rate by switching the bit time

(76) Inventor: Uwe Sydon, Duesseldorf (DE)

Correspondence Address: Siemens Corporation, Attn: Elsa Keller, Legal Administrator, Intellectual Property Department, 186 Wood Avenue South, Iselin, NJ, 08830, US

(21) Appl. No.: 09/922,460

(22) Filed: Aug. 3, 2001

(51) Int. Cl. H04Q 7/20

(52) U.S. Cl. 455/452; 455/450

(57) ABSTRACT

A system for and method of providing a wireless communications air interface with variable data rate by switching the bit time relates to wireless communications systems and methods where low data rate services, such as, voice and high data rate services, such as, data are communicated over a common air interface. This air interface includes a control channel which assigns and changes the data rate to each of several logical communication channels on a per channel basis. As such, logical communication channels can be set to a low data rate for low data rate services and to a high data rate for high data rate services.

### FIELD OF THE INVENTION

The present invention relates generally to telecommunication technologies. More particularly, an exemplary embodiment of the present invention relates to a system for and a method of providing an air interface with variable data rate by switching the bit time.

### BACKGROUND OF THE INVENTION

Modern telecommunication technologies have provided dramatic increases in available bandwidth, allowing for new and improved services to end users. Wireless technologies are an example of telecommunication services or applications which have improved and achieved wide spread use among the public. The availability and presence of wireless technology allows end users to connect to networks, such as, the public switched telephone network (PSTN) without needing a physical communication connection.

Wireless communication technologies have attempted to provide the end user with higher data rate services over wireless communication connections. Higher data rate services allow for wireless Internet and other data applications. Unfortunately, increased or higher data rates lead to a decrease in sensitivity and, thus, a reduction in range. Whereas range may not be as important to data services, lower data rate services, such as, voice services require a good range. Heretofore, conventional air interfaces have provided switchable wireless connections up to 2 Mbit/sec by switching the modulation scheme. However, switching modulation schemes also lead to a reduction in sensitivity and, thus, range.

One example of the importance of finding a solution to these problems is the developing uses of telecommunications at home, where an ever increasing Internet usage is driving increased demands for fast data communications. Indeed, home Internet users may want home telephones or other communication devices which provide and integrate both voice and data services in a mobile fashion, everywhere in the house. To provide such a home telephone, there must be an air interface which provides for voice and data with good quality and range and in a cost effective manner.

Thus, there is a need for a system for and method of providing a wireless telecommunications air interface which includes a good range for low data rate services while also including higher data rate services. Further, there is a need for increased sensitivity in wireless connections capable of both low data rate (e.g., voice) and high data rate (e.g., data) services without switching modulation schemes. Yet further, there is a need for an air interface for wireless telephones which has a variable data rate by switching the bit time.

### SUMMARY OF THE INVENTION

The present invention relates to wireless communications systems and methods where low data rate services, such as, voice and high data rate services, such as, data are communicated over a common air interface. This air interface includes a control channel which assigns and changes the data rate to each of several logical communication channels on a per channel basis. As such, logical communication channels can be set to a low data rate for low data rate services and to a high data rate for high data rate services.

An exemplary embodiment of the invention is related to a method of changing a physical data rate of an air interface on a per channel basis. This method can include providing a plurality of logical communication channels where the plurality of logical communication channels are configured to communicate a signal, providing a control channel that assigns data rates to the plurality of logical channels, and changing the data rates of the plurality of logical channels on a per channel basis.

Another exemplary embodiment of the invention is related to an air interface including at least one logical communication channel configured to communicate a signal and a control channel that assigns a data rate to each of the at least one logical communication channel. The control channel is configured to change the data rate assigned to each of the at least one logical communication channel.

Another exemplary embodiment of the invention is related to a wireless communication system which provides for low data rate services as well as higher data rate services without a reduction in sensitivity characteristic to switching modulation schemes. This communication system can include a communication device capable of receiving and sending communication signals, a base station capable of receiving and sending communication signals, and an air interface of wireless communications between the communication device and the base station. The air interface includes a control channel and a plurality of logical communication channels. The control channel assigns data rates to the plurality of logical communication channels on a per channel basis.

Other principle features and advantages of the invention will become apparent to those skilled in the art upon review of the following drawings, the detailed description, and the appended claims.

### BRIEF DESCRIPTION OF THE DRAWINGS

The exemplary embodiments will hereafter be described with reference to the accompanying drawings, wherein like numerals denote like elements, and:

FIG. 1 is a diagrammatical representation of a wireless communication system in accordance with an exemplary embodiment;

FIG. 2 is a diagrammatical representation of an air interface utilized in a wireless communication system in accordance with an exemplary embodiment; and

FIG. 3 is a flow diagram illustrating steps in a method of operation of the air interface of FIG. 2.

### DETAILED DESCRIPTION OF THE EXEMPLARY EMBODIMENTS

A system for and method of providing an air interface allowing for variable data rate by switching the bit time are described. In the following description, for purposes of explanation, numerous specific details are set forth in order to provide a thorough understanding of the present invention. It will be evident, however, to one skilled in the art that the exemplary embodiments may be practiced without these specific details. In other instances, structures and devices are shown in block diagram form in order to facilitate description of the exemplary embodiments.

In one embodiment, a computer system can be used which has a central processing unit (CPU) that executes sequences of instructions contained in a memory. More specifically, execution of the sequences of instructions causes the CPU to perform steps, which are described below. The instructions may be loaded into a random access memory (RAM) for execution by the CPU from a read-only memory (ROM), a mass storage device, or some other persistent storage. In other embodiments, hardwired circuitry may be used in place of, or in combination with, software instructions to implement the functions described. Thus, the embodiments described herein are not limited to any specific combination of hardware circuitry and software, nor to any particular source for the instructions executed by the computer system.

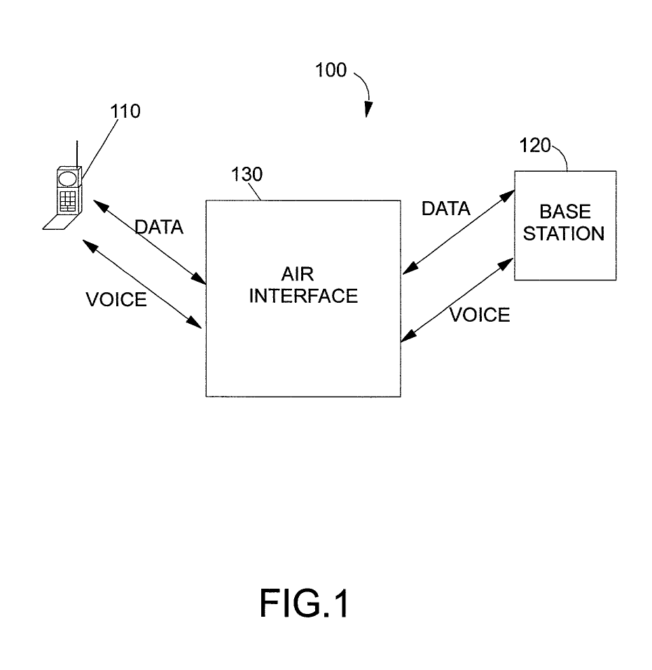

FIG. 1 illustrates a system 100 in which a communication device 110 communicates with a base station 120 via an air interface 130. In an exemplary embodiment, communication device 110 can be a portable telephone, a personal digital assistant (PDA), or other communication device. Base station 120 can be a portable telephone base station, a communication routing device, or any other device that communicates with communication device 110. Air interface 130 can be a wireless communication interface between communication device 110 and base station 120. Communication system 110 and base station 120 can include a computer system that has a central processing unit (CPU) that executes sequences of instructions contained in a memory. As discussed above, hardwired circuitry can be used in addition to, or in place of, computer software or a computer system including a processing unit.

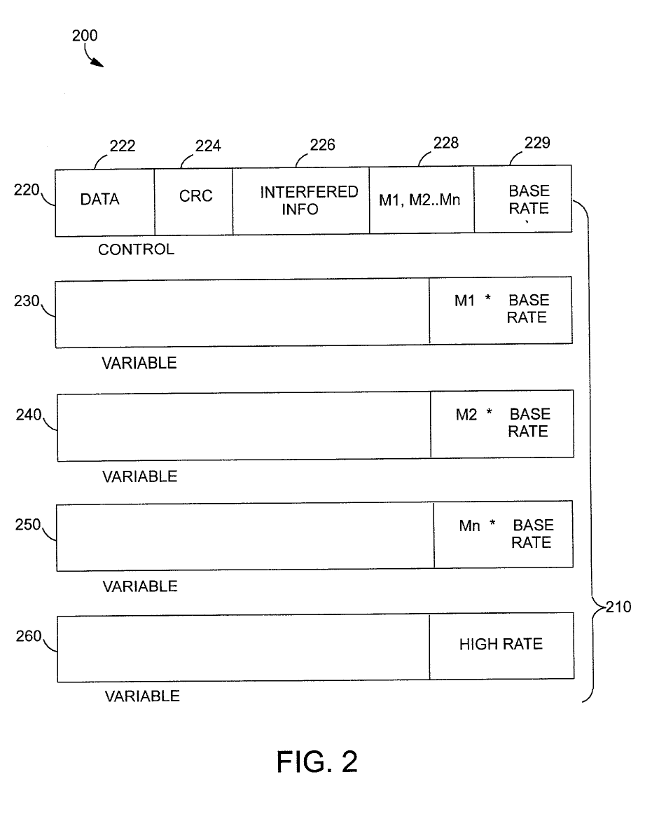

In an exemplary embodiment, system 100 provides for the communication of both voice and data from communication device 110 to base station 120 via air interface 130. Advantageously, air interface 130 has the ability to change its physical data rate on a channel basis. Air interface 130 can use a frequency hopping spread spectrum as a communication transmission method. Alternatively, air interface 130 can use direct sequencing spread spectrum as a communication transmission method. Air interface 130 has the ability to recognize interfered carriers and avoid them. Air interface 130 is described further with reference to FIG. 2.

FIG. 2 illustrates an air interface 200 including communication channels 210. Air interface 200 is a wireless communication interface between communication devices such as the devices in system 100 described with reference to FIG. 1. Communication channels 210 can include a control channel 220, variable data rate channels 230, 240, and 250, and a high data rate channel 260. In other exemplary embodiments, a different number of data rate channels (N) can be utilized, for example, N=four or N=five, where N represents the number of data channels.

In an exemplary embodiment, control channel 220 is configured to assign a data rate to variable data rate channels 230, 240, and 250 and high data rate channel 260. Control channel 220 preferably operates at a lowest possible data rate, such as, 16 k bit/sec. As such, control channel 220 uses a low bandwidth, ensuring a high level of sensitivity. Data rate channels 230, 240, and 250 can be assigned a higher data rate that is a multiple (M) of a basic data rate of control channel 220. For example, data rate channels 230, 240, and 250 can have data rates up to 256 k bits/sec.

Control channel 220 can include communication data 222, cyclic redundancy check (CRC) data 224, interfered carrier data 226, channel data rate data 228, and base data rate data 229. Communication data 222 can be voice information or other data to be transmitted at a low data rate. In general, data transmitted at a low data rate has a higher range than data transmitted at a high data rate. A lower data rate also uses lower bandwidth, ensuring a high level of sensitivity. Sensitivity is generally related to range.

CRC data 224 can be data used in performing CRC checks to determine if logical channels have been disturbed and, therefore, need to be retransmitted. Interfered carrier data 226 can be data transmitted in control channel 220 used to recognize interfered carriers. Channel data rate data 228 can include data regarding data rates for variable data rate channels 230, 240, and 250. Base data rate data 229 can include data regarding the base data rate utilized by control channel 228. An example base data rate is 16 k bit/sec, a low data rate which still achieves acceptable voice quality.

Channel data rate data 228 can include values M₁, M₂, and M_{N}, where N represents the number of variable data rate channels, where M is a value multiplied by the base data rate in base data rate data 229 to obtain a data rate for a particular variable data rate channel 230, 240, or 250. Alternatively, channel data rate data 228 can include the specific data rate for each of the variable data rate channels 230, 240, and 250.

Control channel 220 can assign a data rate to variable data rate channels 230, 240, and 250 based on information about the data to be transmitted. Such information about the type of data to be transmitted can be included in a signal received by control channel 220. As an example, control channel 220 can assign a low data rate where a signal indicates voice data is to be transmitted and a high data rate where a signal indicates computer data is to be transmitted. Such an indication of data type can be included in a communication signal header. Alternatively, information about the data can be determined based on the quality of a signal received or a combination of the quality of the signal and an indication of the data type in the signal. Such information about the data to be transmitted can be derived from the information itself or from a separate source.

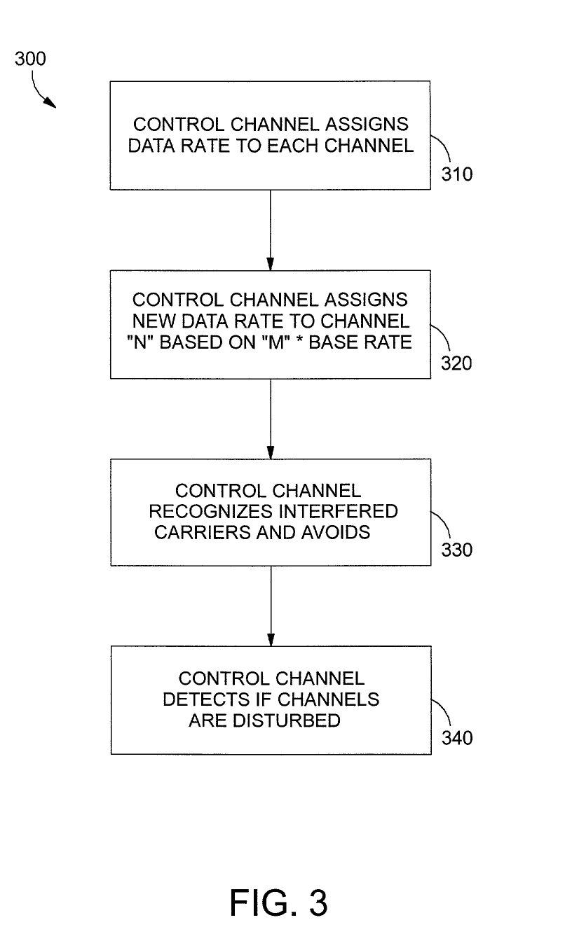

FIG. 3 is a flow diagram 300 illustrating exemplary steps in a method of operation of air interface 200. In a step 310, the control channel assigns a data rate to each logical channel. For example, the control channel can initially assign a pre-determined default rate to each logical channel. After step 310, a step 320 can be performed in which the control channel assigns a new data rate to a logical channel. In an exemplary embodiment, data rates assigned by the control channel to variable data rate channels (in either step 310 or step 320) can be made by assigning logical channel (N) to a multiple of a base data rate (M*base rate). For example, variable data rate channels can be assigned to data rates, such as, 256 k bits/sec or 128 k bits/sec. Example multiples (M) can include 8 or 4, for example.

In a step 330, the control channel can recognize interfered carriers and avoid them. In an exemplary embodiment, the control channel can recognize interfered carriers by using measurements of occurring errors (e.g., bit error rate (BER)) and/or radio signal strength. Interfered carriers are then avoided by being declared or identified as bad and not used. In a step 340, the control channel detects if channels are disturbed. In an exemplary embodiment, the control channel uses CRC checks over part of the bits of a communication channel to decide if the data needs to be retransmitted.

Advantageously, the system and method described with reference to FIGS. 1-3 provides for the capability of changing the bit rate of the communication on a per channel basis. Moreover, the system and method provides a narrow band voice service in combination with a wide band data service, without changing the modulation scheme. Thus, the system and method described has good sensitivity and, therefore, a good range for narrow band services, such as, voice, while also providing wide band services, such as, data.

While the exemplary embodiments illustrated in the figures and described above are presently preferred, it should be understood that these embodiments are offered by way of example only. Other embodiments may include, for example, different techniques for determining channel data rates. The invention is not limited to a particular embodiment, but extends to various modifications, combinations, and permutations that nevertheless fall within the scope and spirit of the appended claims.

What is claimed is:

1. A method of changing a physical data rate of an air interface on a per channel basis, the method comprising:
providing a plurality of logical communication channels, the plurality of logical communication channels being configured to communicate a signal;
providing a control channel that assigns data rates to the plurality of logical channels; and
changing the data rates of the plurality of logical channels on a per channel basis.

2. The method of claim 1, further comprising providing a high data rate channel.

3. The method of claim 1, further comprising using a frequency hopping spread spectrum method to transmit the signal over the plurality of logical communication channels.

4. The method of claim 1, wherein the control channel operates at a low data rate.

5. The method of claim 1, wherein the plurality of logical communication channels operate at a data rate selected by the control channel.

6. The method of claim 5, wherein the selected data rate is a multiple of a basic data rate.

7. The method of claim 1, wherein logical communication channels having a high data rate communicate data information and logical communication channels having a low data rate communicate voice information.

8. The method of claim 7, wherein the high data rate is between 32 k bits/sec and 256 k bits/sec and the low data rate is between 16 k bits/sec and 32 k bits/sec.

9. The method of claim 1, wherein the signal is communicated between a portable telephone and a base station.

10. An air interface comprising:
at least one logical communication channel configured to communicate a signal; and
a control channel that assigns a data rate to each of the at least one logical communication channel, the control channel being configured to change the data rate assigned to each of the at least one logical communication channel.

11. The air interface of claim 10, wherein the control channel changes the data rate assigned to each of the at least one logical communication channel based upon information about data communicated with the signal.

12. The air interface of claim 11, wherein the information about data communicated with the signal comprises data type information.

13. The air interface of claim 11, wherein the information about data communicated with the signal comprises signal quality information.

14. The air interface of claim 10, wherein the communicated signal is transmitted using a frequency hopping spread spectrum method.

15. The air interface of claim 10, wherein the control channel includes interfered carrier information.

16. The air interface of claim 10, wherein the control channel uses cyclic redundancy checks (CRC) to determine whether the at least one logical communication channels are disturbed.

17. A wireless communication system which provides for low data rate services as well as higher data rate services without a reduction in sensitivity characteristic to switching modulation schemes, the communication system comprising:
a communication device capable of receiving and sending communication signals;
a base station capable of receiving and sending communication signals; and
an air interface of wireless communications between the communication device and the base station, the air interface including a control channel and a plurality of logical communication channels, the control channel assigning data rates to the plurality of logical communication channels on a per channel basis.

18. The communication system of claim 17, wherein the air interface includes a high data rate communication channel.

19. The communication system of claim 17, wherein the control channel operates at a lowest possible data rate, thereby using a lowest bandwidth and ensuring best sensitivity.

20. The communication system of claim 17, wherein logical communication channels having a high data rate communicate data information and logical communication channels having a low data rate communicate voice information.

21. The communication system of claim 20, wherein the high data rate is between 32 k bits/sec and 256 k bits/sec and the low data rate is between 16 k bits/sec and 32 k bits/sec.

22. The communication system of claim 17, wherein the communication device is a personal digital assistant (PDA).
